(19) United States
(12) Patent Application Publication
(10) Pub. No.: US 2010/0099502 A1
(43) Pub. Date: Apr. 22, 2010

(54) Custom configurable gaming machine

(76) Inventor: Joseph W. Cole, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 12/653,892

(22) Filed: Dec. 17, 2009

Related U.S. Application Data
(62) Division of application No. 11/205,839, filed on Aug. 17, 2005.
(60) Provisional application No. 60/626,774, filed on Nov. 10, 2004.

(51) Int. Cl. A63F 9/24; A63F 13/00

(52) U.S. Cl. 463/46; 463/30

(57) ABSTRACT

A configurable gaming machine includes a door defining a component area. The component area is configured to accept multiple components, such as displays and player tracking elements, in multiple arrangements, permitting the gaming machine to be constructed in multiple configurations. Other aspects of the invention include an internal component mounting configuration, a door biasing mechanism, a venting configuration, a backlight enclosure, a speaker mount, and a gaming machine stand with integrated footrest.

### RELATED APPLICATION DATA

This application is a divisional of U.S. patent application Ser. No. 11/205,839, filed Aug. 17, 2005, and claims priority to U.S. Provisional Application Ser. No. 60/615,774, filed Oct. 4, 2004.

### FIELD OF THE INVENTION

The present invention relates to gaming machines and, more particularly, to a gaming machine which supports multiple configurations.

### BACKGROUND OF THE INVENTION

Gaming machines, especially those which are utilized to present wagering type games, have a wide variety of configurations. Currently, such machines are custom configured depending on the particular game or games which the machine is intended to present. For example, the machine may be configured to present a video-type wagering game, such as video poker. In that case, the machine will include a video display. The machine may be configured to present a game of slots and an associated bonus game. In that instance, the gaming machine may include a set of rotatable wheels along with a video display for displaying bonus game information.

In order to accommodate the various differing components for presenting these different games, the gaming machines for presenting those games are custom configured for mounting and containing the components.

In addition, it is generally desirable for gaming machines presenting different games to have different appearances. The difference in appearance is useful in aiding player in identifying particular machines. For example, by providing a gaming machine with a particular appearance, one company may distinguish their machines from another company's machines, enabling players to locate those machines.

Unfortunately, there is substantial cost associated with the development of a gaming machine. Significant resources must be expended to engineer the specific gaming machine configuration. Further, custom tooling and parts may need to be created to manufacture the machine. These and other factors increase the cost of producing gaming machines.

As one attempt to reduce the costs of manufacture and make gaming machines more versatile, the inventor herein invented a gaming machine which may be configured as either a reel-type gaming machine or a video-type gaming machine, as evidenced by U.S. Pat. No. 6,475,087. The present invention further addresses the above-stated problems.

### SUMMARY OF THE INVENTION

One aspect of the present invention is a gaming machine which is configured to support a plurality of different configurations. Other aspects of the invention are various features of gaming machines or accessories therefor.

In one embodiment of the invention, a gaming machine includes a housing defining an interior area in which gaming machine components may be located, and a door connected to the housing and moveable between a first position and a second position, the door in the first position generally closing an open portion of a front of the housing and the door in the second position permitting access through the open front portion to the interior area of the housing. The door defines or comprises a component area which defines an opening and which is configured to accept one or more components of the gaming machine, a console area supporting one or more player input devices, and a lower panel area.

In one embodiment, the gaming machine components which are located in the component area of the door are selected from a group including at least one display, a component panel, and a divider. One or more dividers may be used to separate, at least visually, individual components associated with the component area. Various components may be supported by the component panel, such as a media reader, keypad or the like. Preferably, the positions of the components within the component area, as well as their number, may be varied by the manner in which they are mounted to or associated with the door. The door preferably defines an opening at which the components are located, such as by having the display(s) mounted at the opening so as to be viewable by a player of the gaming machine.

In one embodiment, the console area is located below the component area and extends outwardly of a remainder of the door. The console area preferably supports a plurality of input devices such as buttons.

In a preferred embodiment, the lower panel area is defined by a lower panel mounted to the door, the lower panel movable between a closed position over an opening in the door and an open position. One aspect of the invention is a means for biasing the lower panel into its open and closed positions. In a preferred embodiment, this means comprises a piston configured to bias the lower panel towards its open position and at least one spring configured to bias the lower panel towards its closed position.

In one embodiment, the gaming machine housing has a top and a bottom and an opening from the top to the bottom at a front thereof. The door extends from the top to the bottom of the machine for enclosing that opening. The lower panel provides independent access to the interior of the machine through the door.

Another aspect of the invention is an internal component mounting configuration for a gaming machine. In one embodiment, one or more component mounting panels are located inside a housing of a gaming machine for supporting one or more components. Each mounting panel is preferably mounted to an interior of a rear or back portion of the housing, in a vertical orientation. A face of the mounting panel defines a plurality of apertures, permitting a variety of components to be mounted to the panel in various positions or locations.

Another embodiment of the invention is a venting configuration for a gaming machine. A gaming machine includes a light stand which defines one or more vents. The light stand is preferably located at a top portion of the gaming machine and is in communication with an interior of the machine. Heated air from within the machine is permitted to flow upwardly to the light stand, where it exits the machine. In one embodiment, a fan may be used to drive or force air through the machine. One or more inlets may be provided in the gaming machine housing or an associated structure, such as a stand, though which cool air is drawn for replacing the heated air which is expelled.

Another embodiment of the invention is a backlight enclosure for a gaming machine. The backlight enclosure is preferably configured to contain at least one light, such as a flourescent bulb, and be located behind a panel for illuminating the panel. The enclosure is mounted to a support structure in its location behind the panel which is to be illuminated. The enclosure preferably includes at least one access opening, permitting the bulb to be changed without having to disconnect the enclosure from the support structure.

Another embodiment of the invention is a speaker mount for a gaming machine. In one embodiment, one or more speakers are configured for location in the coin tray of a gaming machine. Each speaker includes a housing containing a sound-generating device. The housing is configured to fit within the coin tray. In one embodiment, speakers are located at opposing ends of a coin tray of the gaming machine.

Yet another embodiment of the invention is a gaming machine stand with integrated footrest. The stand preferably has an open front leading to a foot-rest area. The foot-rest area preferably has an upwardly sloping bottom surface. In one embodiment, a gaming machine is configured to rest upon a top surface of the stand over the foot-rest area. Apertures may be provided in the top surface of the stand through which wires may extend from the gaming machine. The stand may define a generally enclosed storage area in which one or more components may be located.

Further objects, features, and advantages of the present invention over the prior art will become apparent from the detailed description of the drawings which follows, when considered with the attached figures.

### DESCRIPTION OF THE DRAWINGS

FIG. 1 is a perspective view of an embodiment gaming machine of the present invention arranged into a first configuration;

FIG. 2 is a perspective view of an embodiment gaming machine of the present invention arranged into a second configuration;

FIG. 3 is a perspective view of an embodiment gaming machine of the present invention arranged into a third configuration;

FIG. 4 is a perspective view of an embodiment gaming machine of the present invention arranged into a fourth configuration;

FIG. 5 is a perspective view of an embodiment gaming machine of the present invention arranged into a fifth configuration;

FIG. 6 is a perspective view of an embodiment gaming machine of the present invention arranged into a sixth configuration;

FIG. 7 is a perspective view of an embodiment gaming machine of the present invention arranged into a seventh configuration;

FIGS. 8 and 9 illustrate a component mounting configuration for a gaming machine in accordance with an embodiment of the present invention;

FIG. 10 illustrates a panel opening/closing biasing mechanism in accordance with an embodiment of the present invention;

FIG. 11 illustrates a speaker mounting configuration of a gaming machine in accordance with an embodiment of the present invention;

FIGS. 12-14 illustrate a gaming machine venting system in accordance with an embodiment of the present invention;

FIGS. 15 and 16 illustrate a light enclosure for a gaming machine backlight in accordance with an embodiment of the present invention; and

FIGS. 17 and 18 illustrate a gaming machine stand with integrated footrest in accordance with an embodiment of the present invention.

### DETAILED DESCRIPTION OF THE INVENTION

The invention is a gaming machine, the machine including a housing or cabinet permitting multiple configurations of the machine, as well as various other gaming-machine related components and configurations. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

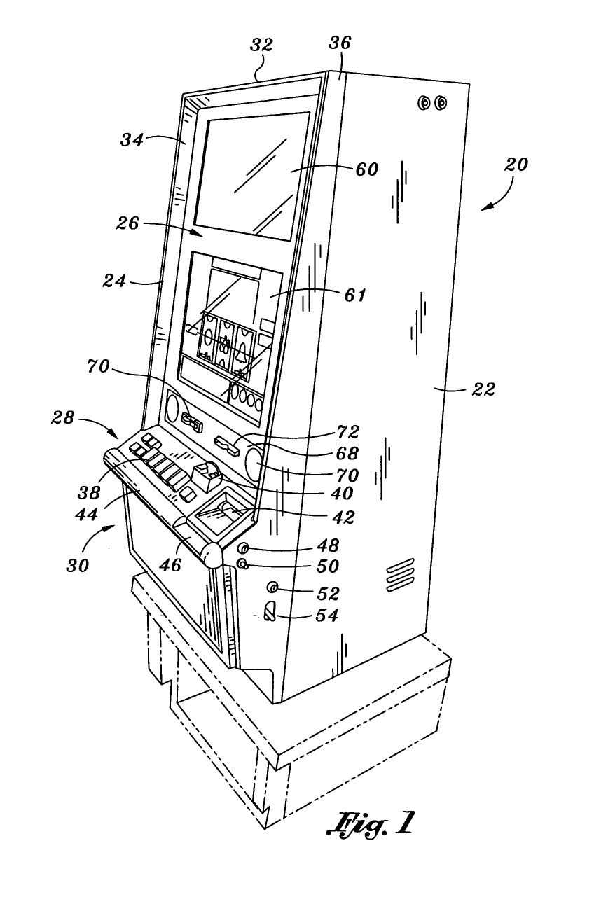

One embodiment of the invention is a gaming machine permitting multiple configurations. FIG. 1 illustrates one embodiment of such a gaming machine 20 in accordance with the present invention. The gaming machine 20 includes a housing or cabinet 22. The housing or cabinet 22 is configured to support and/or contain one or more gaming machine components.

The housing 22 may have a variety of configurations and be a variety of shapes and sizes. As illustrated, the housing 22 is configured so that the gaming machine 20 has an “upright” configuration. In this configuration, the housing 22 has a top, a bottom, a pair of opposing sides and a back (not visible).

A door 24 is located at a front of the housing 22. The door 24 is movable between a first, open position whereby access is permitted to an interior of the gaming machine 20, and a second, closed position (as illustrated in FIG. 1) in which access to the interior is generally prevented. In the embodiment illustrated, the entire front of the housing 22 is, when the door 24 is in it second position, closed by the door 24. In other embodiments, the door 24 could be smaller than the entire front of the housing 22, such that the door 24 allows access to only a portion of the interior of the housing 22, the remaining front portion of the housing closed by panels, housing wall members or the like.

The door 24 defines a component area 26, a button panel, mount or console area 28, and a lower panel 30. In a preferred embodiment, the component area 26 is positioned above the button panel 28, and the lower panel 30 is positioned below the button panel 28.

As illustrated, the component area 26 is a space between the button panel 28 and a periphery of the door 24, that periphery having a top portion 32 and side portions 34,36. In one embodiment, the component area 26 is generally rectangular in shape, being about twelve to twenty (12-20) inches in width and about twenty-four to thirty-six (24-36) inches in height.

As described in more detail, the component area 26 is configured to accept a plurality of gaming machine components. Preferably, one or more of the components are mounted to the door 24, and face outwardly towards a player of the game. The components may include, but are not limited to, displays such as LCD, LED, CRT, plasma, DLP and others, keypads, media printers (such as ticket printers and bar code printers) and readers (such as bill validators, ticket readers, smart card and magnetic stripe card readers), speakers and other devices.

Preferably, the button panel 28 comprises an outwardly extending support portion of the door 24. As illustrated, the button panel 28 includes an outwardly extending, somewhat downwardly sloping support surface. Preferably, one or more components of the gaming machine 20 are supported or associated with the button panel 28. In one embodiment, these components include one or more buttons 38 or other devices for accepting player input, a coin acceptor 40 and a media reader 42 (such as a bill validator). Other or additional components may be provided. In particular, as detailed below, the components which are associated with the button panel 28 may vary depending upon the components which are located elsewhere on the machine and the desired configuration of the machine, among other factors.

In one embodiment, a bumper or cushion 44 is provided at front edge of the button panel 28. Preferably, the bumper 44 comprises a cushioned or somewhat compressible member. In one embodiment the bumper 44 may be constructed of a foam material covered by a protective coating or cover.

In a preferred embodiment, the bumper 44 extends from one side of the button panel 28 to the other, thus providing a cushion at the front or outer-most extending portion of the button panel 28. As illustrated, a cut-out or trough area 46 may be provided in the bumper 44 in order to facilitate access to the media reader 42. As illustrated, this cut-out or depression 46 is located in a top portion of the bumper 44 in alignment with a guideway portion of the media reader 42.

The lower panel 30 preferably covers one or more gaming machine 20 components located there behind, such as within the housing 22 of the gaming machine 20. Greater details of the panel 30 are provided below.

In one embodiment, the lower panel 30 may include a latching and/or locking mechanism which controls movement of the panel 30 between an open and closed position. In one embodiment, a locking mechanism includes a key-actuated lock 48. A latching mechanism includes a movable lever 50. In a preferred configuration, the movement of the lever 50 may be utilized to unlatch the panel 30, permitting its movement from a closed to an open position. Preferably, movement of the lever 50 is controlled by the lock 48. When the lock 48 is locked, then the lever 50 can not be actuated and the panel 30 can not be opened. As illustrated the lock 48 and lever 50 are preferably mounted to the door 24.

Movement of the door 24 from the closed to the open position may be similarly controlled. As illustrated, a door lock 52 and lever 54 are preferably mounted to the housing 22.

Advantageously, the gaming machine 20 of the invention may be assembled so that the gaming machine 20 has a variety of different configurations. Preferably, the gaming machine 20 may also be converted between a first and at least one second (or other) configuration. In this manner, the gaming machine 20 may be custom configured to include specific desired components and to have a specific desired appearance, from among many different possible combinations of components and many possible different possible appearances.

In a preferred embodiment, the ability to configure or convert the gaming machine 20 is facilitated by the ability to arrange components within the component area 26 of the gaming machine 20. In addition, however, other components may be associated with the button panel 28.

FIG. 1 illustrates one example configuration of the gaming machine 20. As illustrated, in this embodiment, two displays 60,61 are located in the component area 26, as well as a component bar or panel 68. In the embodiment illustrated, the component bar or panel 68 supports components of a player tracking device, including speakers 70, a media reader 72 (such as a magnetic stripe card reader) and a media printer 74 (such as ticket printer). Additional details of configurations of the gaming machine and the construction of the gaming machine are provided below.

FIGS. 2-7 illustrate additional example configurations of a gaming machine 20 in accordance with the present invention. It will be appreciated that these figures illustrate just a few of the possible configurations for the gaming machine.

FIG. 2 illustrates an embodiment of a gaming machine 20a in which a single display 60a is located in the component area 26a and is configured to present game and other information to a player/user of the machine 20a. In one embodiment, the display 60a is a thirty (30) inch LCD display, which display occupies substantially all of the component area 26a.

In a preferred embodiment, the button panel 28a of this machine supports a plurality of input buttons 38a, a media reader 62a (such as a magnetic stripe card reader or smart card reader), and a coin acceptor 40a. Of course, the button panel 28a might support other components.

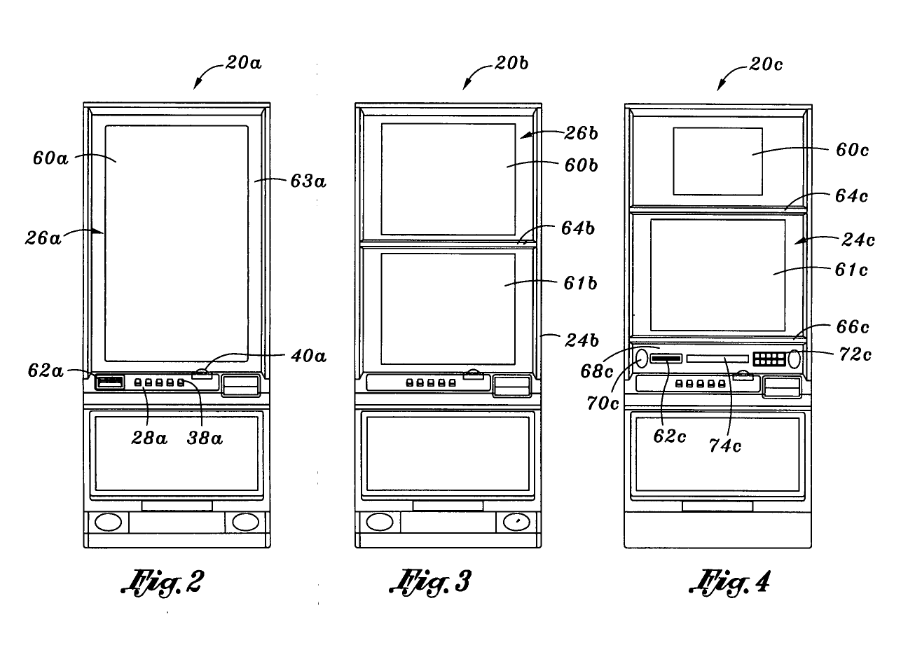

FIG. 3 illustrates yet another configuration of a gaming machine 20b in accordance with the invention. In this embodiment, a first display 60b and a second display 61b are located in the component area 26b. In this embodiment, the first and second displays 60b,61b are generally of the same size, such as nineteen (19) inch LCD panels.

Preferably, the displays 60b,61b are separated by a divider 64b. In one embodiment, the divider 64b is a raised bar which extends between the opposing sides of the periphery of the door. The periphery of the door may comprise a raised beveled member which extends outwardly to “frame” the component area 24b. The divider 64b may be similarly configured, so as to have the same appearance. In a preferred embodiment, the divider 64b is selectively connectable to the door 24b. In this manner, the position of the divider 64b may be changed. However, because the divider 64b has the same appearance as the peripheral portion of the door 24b, the divider 64b makes it appear that the door is actually constructed to have two different areas, one for each display.

Of course other divider configuration may be provided. In one embodiment, the divider may be mounted from inside the door and be a bar or other member extending across the opening comprising the component area. Preferably, the divider or dividers may be mounted to the door in a variety of locations to facilitate the multiple configurations of the gaming machine. In one embodiment, mounting brackets supporting multiple divider mounting positions may be provided.

This configuration gaming machine 20b has particular utility in the situation where two different games are to be presented to a player. The gaming machine 20b may, however, be configured to present a wide variety of information on either or both displays 60b,61b.

FIG. 4 illustrates yet another configuration of a gaming machine 20c in accordance with the invention. In this configuration, the gaming machine 20c again includes a first display 60c and a second display 61c located in the component area 24c. The size and configuration of these displays 60c,61c may vary. As illustrated, the first display 60c is smaller than the second. For example, the first display 60c may be a twelve (12) inch LCD panel and the second display 61c may be an eighteen (18) inch LCD panel. Of course, the displays may be of a variety of shapes and/or sizes.

In this embodiment, a component panel 68c is also located in the component area 24c. The component panel 68c supports and presents one or more components. As illustrated, the component bar or panel 68c is supporting one or more speakers 70c, a media reader 62c, a keypad 72c, and small display 74c.

In a preferred embodiment, the displays 60c,61c are separated from one another by a first divider 64c, and the component panel 68c is separated from the displays 60c,61c by a second divider 66c.

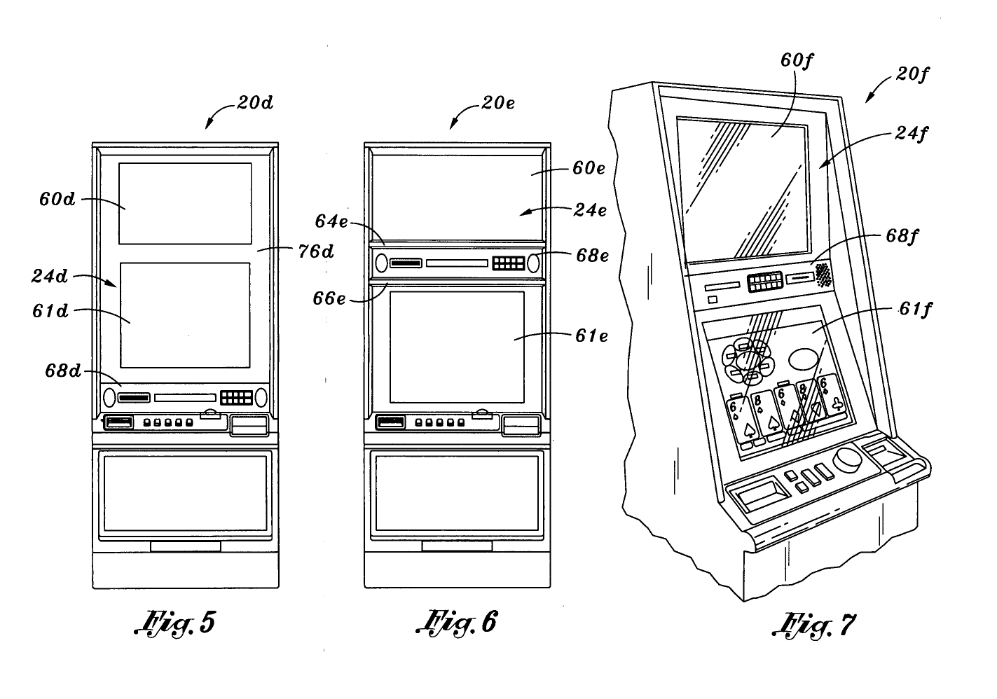

Yet another embodiment of a gaming machine 60d is illustrated in FIG. 5. This embodiment machine 20d is similar to that illustrated in FIG. 4, except that the displays 60d,61d and component panel 68c are not separated from one another by dividers. Instead, the displays 60d,61d are surrounded by a bezel 76d. The bezel 76d preferably separates the displays 60d,61d and component panel 68d from one another visually.

Yet another embodiment gaming machine 20e is illustrated in FIG. 6. In this embodiment, the component area 24e includes a first display 60e, a component bar or panel 68e, and then a second display 61e. These components are again preferably separated by dividers 64e,66e.

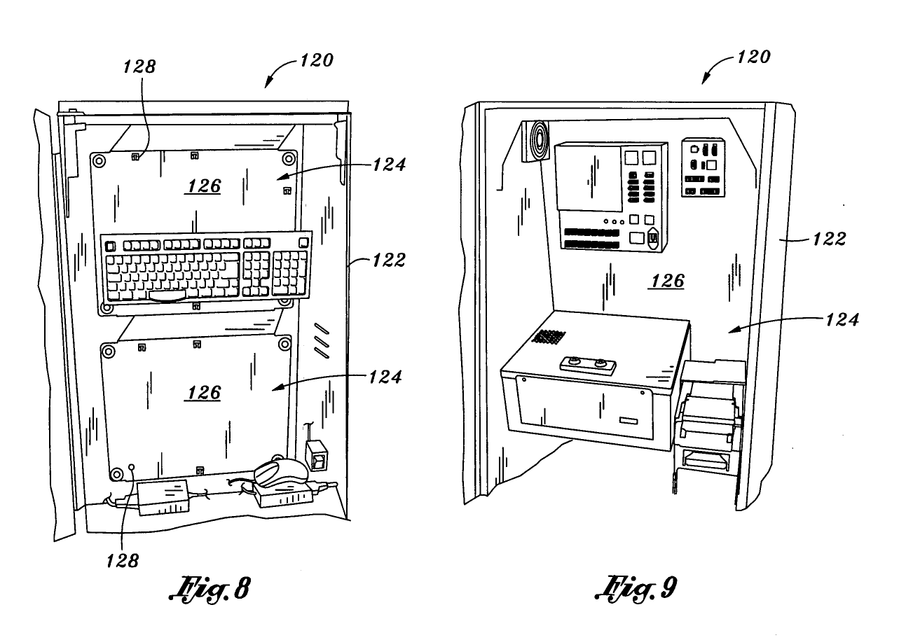

Another embodiment gaming machine 20f is illustrated in FIG. 7. This embodiment gaming machine 20f is similar to that illustrated in FIG. 6. In particular, a component area 24f thereof includes first and second displays 60f,61f separated by a component bar or panel 68f. In the illustrated configuration, one or more brackets are utilized to connect the displays to the machine 20f in a manner by which they are tilted or angled. In one embodiment, as illustrated in FIGS. 1-6, the displays may be mounted so that they are generally vertically extending. As illustrated in FIG. 7, the displays may also be mounted so that are located in one or more planes which are offset from vertical.

In one embodiment, as illustrated in FIG. 7, a first or top display 60f may be mounted so as to tilt forward or downwardly towards the eyes of a player which are normally located below the height or level of the display. The second or bottom display 61f may be mounted so as to tilt backwardly or upwardly towards the eyes of a player which may be located at or above the height of this display. In this manner, the displays 60f,61f lie in planes which intersect at a point behind them. The displays 60f,61f could be mounted in other planes. The particular mounting illustrated is advantageous where the machine is to be situated such that the player's level line of sight is directed to a point generally between the displays 60f,61f, so that when the player is looking down towards the lower display 61f, that display is tilted up towards the player and so that when the player is looking up towards the top display 60f, that display is tilted down towards the player.

As described, the displays 60f,61f may be mounted to a door of the gaming machine 20f with one or more brackets into the illustrated position. In one embodiment, the component bar 68f is still mounted so as to be generally vertically extending.

Once again, it is emphasized that the embodiments of the gaming machine illustrated in FIGS. 1-7 are examples of various configurations of the gaming machine permitted in accordance with the invention. Many other configurations are permitted. For example, in one embodiment, the display may comprise a static graphical display panel, such as a painted glass panel. Such a panel, which is often back-lit, may be located in a first portion of the component area and one or more electronic displays may be located at other portions of the component area.

Additional details of the gaming machine 20 will now be described with reference again to FIGS. 1-7. As indicated, one or more displays and other components may be associated with the component area 26 of the gaming machine 20.

In a preferred embodiment, components such as the displays, component panels and the like are mounted to the door 24. In one embodiment, the component area 26 comprises a display window or opening, that window or opening framed by the door. The displays and other components are preferably connected to the door so as to be viewable through the opening in the door. The components could also be located at the front of the door for access/viewing. In such a configuration, the components need not be aligned with an opening in the door.

One embodiment of a mounting configuration for a display, such as an LCD panel, is detailed in U.S. Pat. No. 6,860,814 which is incorporated by reference in its entirety herein. As disclosed therein, such panels may be mounted to a rear of the door 24 so as to be visible through the opening comprising the component area 26.

In one embodiment, glass or a similar suitable covering may be located over the displays for protecting the surfaces of the displays. For example, in the embodiment gaming machine 20a illustrated in FIG. 2, the entire opening or area defined by the component area 26 may be filled or covered with glass or other transparent protective member. In the example illustrated in FIG. 4, glass may cover the displays 60c,61c, but not the component panel 68c.

As indicated, a bezel may be located around the display or displays or other components, for setting those components off from one another visually. For example, the display 60a of the gaming machine 20a illustrated in FIG. 2 may have a bezel 63a around its periphery. The bezel 63a may comprise a printed portion of the covering glass, such as a black painted border, or may comprise a physical element such as a frame element. The frame element may be mounted to the door 24a or the like, such as in front of the display 60a and/or glass or other covering over the display.

In the case of the gaming machine 20b illustrated in FIG. 3, there may be more than one bezel, or there may be a single bezel, with the divider 64b extending over the bezel.

It will be appreciated that the configuration of elements associated with the button panel 28 may vary, including as dependent upon what components are located in the component area 26. For example, if a media reader, such as magnetic-stripe card reader or smart card reader, is located in the component area (such as associated with a component panel, as illustrated in FIG. 4), then that component may not need to be located at the button panel 28 or elsewhere on the machine.

As indicated, the gaming machine may be configured to support other components. For example, the gaming machine might be configured as a reel-type machine and include one or more reels which are mounted for display in the component area (such as mounted to the door or there behind for viewing through the opening).

Advantageously, this aspect of the invention provides a “generic” gaming machine structure which allows for multiple component configurations, thus allowing the gaming machine to be “customized.” The embodiment gaming machine thus substantially reduces the cost associated with production of gaming machines having a variety of different configurations. At the same time, the gaming machine supports a nearly limitless number of configurations. This allows production of various gaming machines which have unique appearances.

The number of appearances of the gaming machine may be further enhanced with superficial effects. For example, the door perimeter, dividers and the like may be chrome or gold plated or otherwise colored in a various shades, and the lower panel may include various graphics, among other things. This further enhances the ability to make the gaming machine distinct in appearance. For example, various configurations of the gaming machine may be developed for “themed” games, and the graphics and the like may be provided to match and promote that theme.

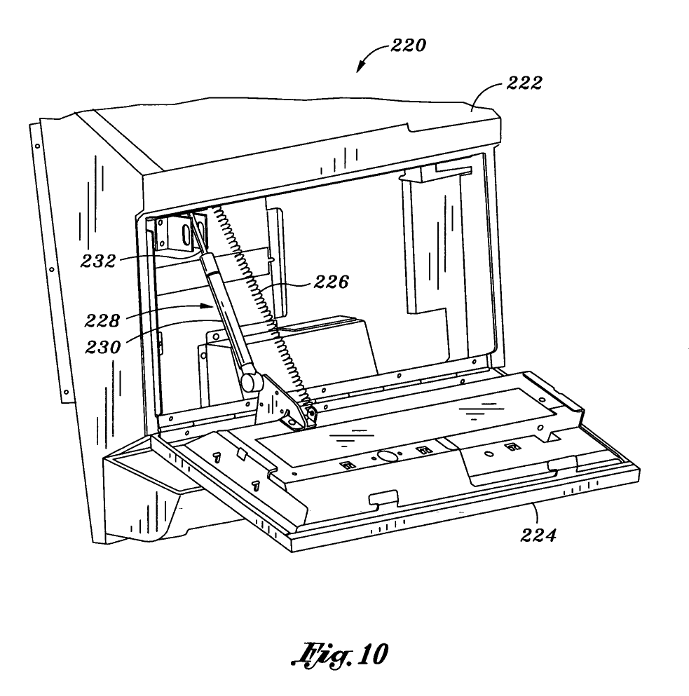

Various other aspects of the invention will now be described. Referring to FIGS. 8 and 9, one embodiment of the invention is an internal component mounting arrangement for a gaming machine. FIG. 7 illustrates a gaming machine 120 having a housing or cabinet 122. The housing 122 may be configured similar to that of the gaming machine 20 illustrated in FIG. 1, and may include one or more doors or other access panels to an interior thereof.

In a preferred embodiment, one or more component mounting panels 124 are located at the interior of the housing 122. In the embodiment illustrated, two mounting panels 124 are located a rear or back of the housing 122 at the interior thereof.

The mounting panel 124 preferably defines a generally planar mounting surface 126. In one embodiment, the mounting surface 126 of the panel 124 is offset or spaced outwardly from the rear of the housing 122. For example, in one embodiment, the panel 124 comprise a metal sheet having portions of one or more edges bent rearwardly, thus defining feet extending from the mounting surface 126, those feet when engaging the rear of the housing 122 offsetting the mounting surface 126 from the housing 122. Of course, other means may be provided for spacing the mounting surface 126 from the housing 122, such as legs, spacers and the like.

The mounting panel 124 is connected to the housing 122. In one embodiment, this may be accomplished with fasteners. Welding or other means of connection may alternately be provided. Preferably, so connected to the housing 122, the mounting surface 126 of the panel 124 is generally vertically extending.

In one embodiment, a plurality of apertures 128 are provided in the mounting surface 126. The apertures 128 are configured to accept fasteners for mounting components of the gaming machine 120 thereto. The fasteners may comprise hooks, bolts or other elements. The fasteners may be separate from or integral with the gaming machine component(s).

FIG. 8 illustrates various components mounted to the two mounting panels 124. As illustrated, these components comprise a keyboard, among other things. The particular components which are mounted to the one or more mounting panels may vary. For example, FIG. 8 illustrates an embodiment where a gaming machine CPU or controller and various other components are mounted to a large panel 124.

This component mounting configuration has numerous advantages over current mounting configurations. Currently, shelves or racks are generally located in the gaming machine to provide horizontal support surfaces for components. These horizontal shelves and racks suffer from a number of drawbacks. First, the shelves dictate where components may be located. For example, depending upon the spacing between shelves, certain components may not fit between closely spaced shelves, but must be placed elsewhere. In addition, these shelves severely interfere with the flow of air through the gaming machine, making it more difficult to cool the components.

In accordance with the mounting configuration of the invention, components of the gaming machine may be mounted anywhere in the gaming machine. This allows the gaming machine to be customized for each particular application. For example, when considering the gaming machine configuration illustrated in FIGS. 1-7, displays and other devices may be associated with the door in a plurality of configurations. In accordance with the component mounting configuration, the supporting infrastructure of the gaming machine may be altered depending upon that gaming machine configuration. For example, the position of a CPU or controller of the device may be moved to accommodate a display, card reader or the like which is mounted to the door and extends into the gaming machine.

In addition, this mounting configuration permits the interior of the gaming machine to remain substantially open. This allows air to more freely flow through the gaming machine to cool the components. The configuration also promotes access to the components for replacement and repair.

Referring to FIG. 10, one embodiment of the invention is a biasing mechanism for a gaming machine door or panel which may be moved between open and closed positions. As illustrated, a gaming machine 220 has a door or access panel 224. The door or access panel 224 is preferably moveable between a first and second position. As mounted to a housing 222 of the gaming machine 220, the door or access panel 224 ma_{y} selectively provide access to the interior of the housing 222. One such panel 30 is illustrated in the gaming machine 20 illustrated in FIG. 1.

In the embodiment illustrated, the access panel 224 is hingedly mounted to the housing 222. In a preferred embodiment, means are provided for controlling movement of the panel 224 to an open position and for controlling movement of the panel to its closed position. In one embodiment, these means comprise means for biasing the panel towards an open position and means for biasing the door towards a closed position.

In a preferred embodiment, a spring 226 is connected to the door panel 224 and another member, such as a the housing 222 which supports the panel 224. As illustrated, the spring 226 may be a coil-type spring having one end connected to the panel 224 and the other connected to the housing 222. Preferably, the spring 226 is configured to bias the panel 224 towards its closed position.

A piston 228 preferably biases the panel 224 towards its open position. In the embodiment illustrated, the piston 228 has a body 230 and an arm 232. Preferably, the arm 232 is biased outwardly towards an extended position. One end of the piston 228, such as at the arm 232, is connected to the housing 222 or other support. The other end of the piston 228, such as at the body 230, is connected to the panel 230.

Preferably, the biasing forces generated by the two biasing means (in this case the spring 226 and piston 228) are carefully selected so that: (1) when a user desires to move the panel 224 from a closed to the open position illustrated in FIG. 10, the user pulls the panel 224, the piston 228 aiding in moving the pane 224 towards the open position against the biasing force generated by the spring 226, the panel 224 once in its open position being retained in that position by the piston 228 against the biasing force generated by the spring 226; and (2) when a user desires to move the panel 224 from the open back to the closed position, the user moves the panel, the spring 226 biasing the panel 224 towards the closed position against the force of the piston 228.

So configured, a biasing force aids in moving the panel 224 in each direction of movement. At the same time, a biasing force is generated which opposes movement of the panel 224, thus preventing undesirable “slamming” of the panel 224 as it is moved back and forth. For example, when the panel 224 is opened, the spring 226 serves to reduce the speed at which the panel 224 may be opened, lessening the likelihood of the panel 224 slamming open and being damaged. Likewise, the piston 228 prevents slamming of the panel 224 as it is moved to its closed position, protecting the panel 224 and components of the gaming machine located there behind.

Of course, other means may be provided which accomplish the above-stated functions. For example, more than one spring may be used. Other means for biasing may also be utilized, such as elastic cords and bands and the like.

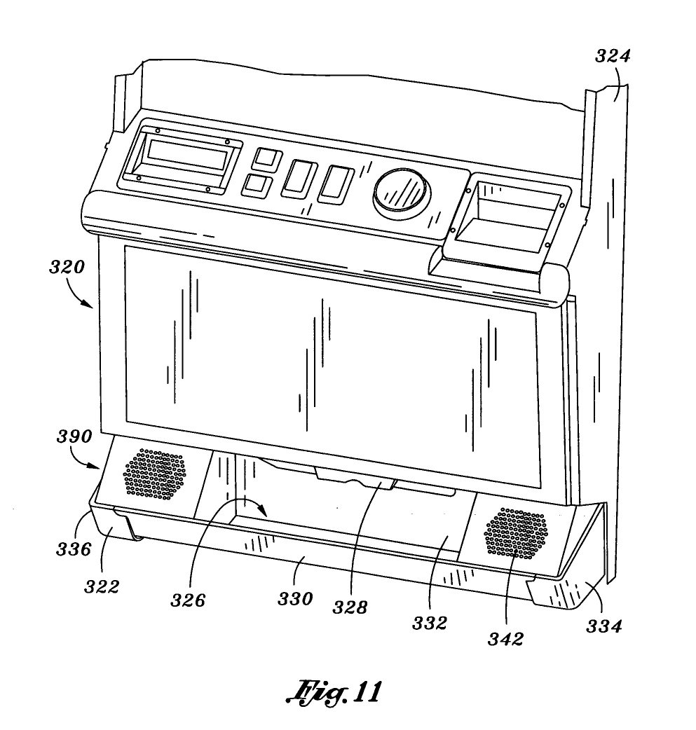

One embodiment of the invention is a gaming machine including one or more sound-generating devices such as speakers. Referring to FIG. 11, a gaming machine 320 is illustrated. The gaming machine 320 may be similar to the gaming machine 20 illustrated in FIG. 1, or may have a wide variety of other configurations.

As illustrated, the gaming machine 320 includes a coin tray 322. In one embodiment, the coin tray 322 is mounted to a door 324 of the gaming machine 320. The coin tray 322 may be supported by a housing or other component of the machine 320, or by an external member.

As illustrated, the coin tray 322 defines a trough 326 into which coins, token or the like may be dispensed. In the embodiment illustrated, coins may be dispensed from a slot at the end of a coin delivery chute (not visible) leading from an interior portion of the gaming machine 320. In the embodiment illustrated, and applicable to other embodiments of gaming machines described herein, a media printer is configured to dispensed media, such as printed tickets or the like, through a dispenser 328 to the coin tray 322.

In one embodiment, the trough 326 is defined by a front wall 330 and a rear wall 332. Ends of the trough 326 may be closed with end members 334,336. In one embodiment, the end members 334,336 may be formed as separate elements from the front and/or rear walls 330,332.

In the embodiment illustrated, the trough 326 is elongate, and relatively shallow in depth and height. The trough 326 may have a variety of shapes, however. For example, the trough 326 may be relatively short, but have a greater depth (i.e. distance from front to rear wall) or height dimension. In this manner, the trough 326 may catch and hold a plurality of coins, tokens or the like dispensed into the tray 332.

In accordance with the present invention, one or more speakers 340 or other sound generating devices are located in the coin tray 322. Preferably, the speakers 340 are located within the trough 326 of the coin tray 322 and are configured to direct sound outwardly of the trough. In the embodiment illustrated, the speakers 340 include sound-generating devices (not visible) which are located in housings. Each housing has one or more apertures or grills 342 through which sound is directed.

In the preferred embodiment, the housings of the speakers 340 are configured to fit within the trough 326. The apertures/grills 342 through which sound is directed are oriented to direct sound towards a player of the gaming machine. In the embodiment illustrated, the gaming machine 320 is an “upright” type gaming machine where the coin tray 322 is located at the bottom of the machine 320. In this configuration, the coin tray 322 is generally located well below a player's head (and ears), whether the player is standing or sitting. As such, the speakers 340 are preferably configured to direct sound upwardly and outwardly of the trough. Of course, the speakers 340 might be oriented differently if they are located in a different position on the machine, and thus in a different location relative to the player.

The speakers 340 are preferably connected to the coin tray 322 or an associated structure, so that they are not removed by players or other parties.

In a preferred embodiment, the speakers 340 are located at opposing ends of the trough 326, such that they are separated from one another. The remaining space of the trough 326 between the speakers 340 provides an area for collection of dispensed coins/tokens/tickets (or other media).

It is noted that the speakers may be of a variety of types, such as small horn, diaphragm, electro-static or the like. Preferably, a signal is provided to the speakers 340, causing the speakers to generate sound. The signal may be generated or provided by a wide variety of devices, such as a small amplifier (not shown).

This arrangement has a number of advantages. First, the speakers 340 are located in the coin tray 322, and thus do not occupy any of the space within the gaming machine 320. This frees space within the gaming machine 320 for other components. In addition, the speakers then do not occupy any space in the main area of the gaming machine which is necessary for displays, buttons and the like.

In addition, the “trough” configuration of the coin bowl 322 acts as a sound-concentrating and directing device for the speakers 340, improving the sound quality and output level of the speakers. In particular, while much of the sound generated by the speakers 340 is directed outwardly, other sound waves are directed inwardly. In this case, those sound waves are reflected back outwardly. In addition, the spacing of the speakers 340 improves channel separation, thus improving the “stereo” effect when the speakers 340 generate sounds associated with different signals (such as left and right stereo signals).

Another embodiment of the invention is a venting configuration for a gaming machine. Referring to FIG. 12, a gaming machine 420 includes a housing or cabinet 422. In one embodiment, the housing 422 has a top. In the embodiment illustrated, the top of the housing 422 is rounded. The housing may have other configurations, such as illustrated in FIG. 1 where the top of the housing is generally flat.

In accordance with the invention, means are provided for venting air from inside of the housing or cabinet 422 to a point exterior thereto, at a top of the housing. In a preferred embodiment, at least one opening or vent through which air may flow is provided at a top of the housing 422. The at least one opening or vent allows warm air within the housing 422 to flow to the exterior of the housing 422, for replacement by cooler air.

In a preferred embodiment, a light stand 424 is located at a top portion of the housing 422. In a preferred embodiment, the light stand 424 is located at the highest or top-most portion of the housing 422.

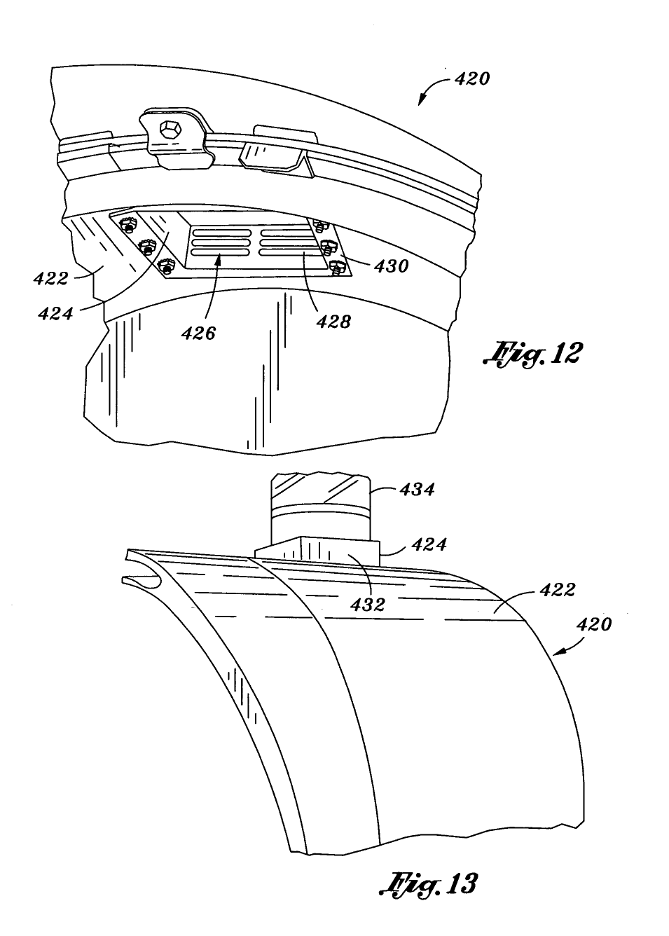

As illustrated in FIG. 13, the light stand 424 defines a flow path from the interior of the housing 422 to a point exterior thereto. Thus, in a preferred embodiment, an opening is provided in the housing 422. The stand 424 is connected to the housing 422 at the opening, the stand defining an air flow passage 426. The stand 424 includes one or more vents or openings 428 which extend to an exterior of the stand 424. The air flow passage 426 leads from the interior of the housing 422 to the one or more vents 428, which vents 428 then lead to a point exterior to the housing. In this manner, heated air is allowed to flow from within the housing 422 to a point exterior to the housing 422.

In one embodiment, the light stand 424 has a base portion 430 which connects to the housing 422. A riser portion 432 extends from the base portion 430. When the base portion 430 is connected to a housing 422, the riser portion 432 thus extends upwardly beyond the top of the gaming machine 420, as illustrated in FIG. 13.

The light stand 424 may have a variety of configurations. In the embodiment, the stand 424 has a generally square perimeter having four sides. As illustrated, the vents or openings 428 may be provided in a rear side (when viewing the front of the gaming machine). The vents 428 may have a variety of configuration. In one embodiment, the vents 428 may be elongate slots formed in a side of the stand 424.

The light stand 424 is preferably also utilized to support a gaming machine light 434. The light 434 may have variety of configurations. In one embodiment, the light 434 may be cylindrical in shape. The light 434 may be used to signal the need for service, such as in the event of machine malfunction or a jackpot award. As illustrated in FIG. 13, the light 434 may be mounted to the top of the stand 424 and extend upwardly therefrom.

In one embodiment, means may be providing for forcing air through the vents 428. A fan may be provided for directing air towards and through the vents 428 to a point exterior to the housing 422. In one embodiment, the fan may be mounted at the base portion 430 of the stand 424. The fan may be located in a housing which defines a flow path having an inlet and an outlet. The inlet may be in communication with the interior of the housing 422 and the outlet may be in direct communication (and preferably is sealed to) with the air passage 426 defined by the stand 424. The fan may be electrically powered and be configured to draw air from within the housing 422 and expel it under pressure or with force to the stand 424, and through the vents 428 thereof to the exterior of the housing.

FIG. 14 illustrates a preferred embodiment of a venting configuration including a fan 436. As illustrated, the fan 436 is located inside of the housing 422 beneath the stand 424. In the preferred embodiment, a body 438 comprises a duct which defines a plenum or path 440 leading from the interior of the housing 422 to the air flow path 426 defined by the stand 424. As illustrated, the body or duct 438 has a top end 442 which defines one or more mounting elements or surfaces, such as the pair of outwardly extending flanges which are illustrated, for connecting the body or duct 438 to the housing 422 at the opening leading to the stand 424. The body 428 may be mounted to the housing 422 using one or more of the same fasteners which mount the stand 424 to the housing. A seal (not shown) may be located between the first or top end 442 of the body 438 and the adjacent surface of the stand 424 or housing 422 for sealing the flange thereto and reducing the leakage of air there between.

A main portion of the body 438 comprises a wall which extends from the top end 442 to an opposing second end 444. In one embodiment, the body 428 is generally square in cross-sectional shape (thus having four sides). The body 428 could have a variety of other shapes (such as circular or rectangular), however, and may have a variety of sizes/dimensions.

The fan 436 is mounted to the body 438. Preferably, the fan 436 is located at the second end 444 of the body 438 or within the plenum or air path 440 defined there through. In this manner, the fan 436 is configured to draw air from within the housing 422 and direct all of that air through the plenum 440 of the body 438 to the air flow path 426 defined by the stand 424. In a preferred embodiment, the fan 436 is a self-contained unit which includes a housing for a turbine/propeller (or other air moving element(s)), and a motor. The housing of the fan 436 may be connected to the body 428, such as with one or more fasteners, so as to be replaceable.

In one embodiment, one or more vents or openings may be provided for allowing fresh, cool air into the gaming machine to replace the air which is being expelled through the vents 428. In one embodiment, one or more vents are provided at a lower portion of the machine. In this manner, cool air enters at or near the bottom of the machine and is permitted to circulate around heated components to cool them. The then heated air rises towards the top of the machine via convection and/or flows to the low pressure area generated by the one or more fans.

In one embodiment, at least one vent or opening is provided near a coin tray of the machine. Referring to FIG. 11, the coin tray is preferably located near a bottom of the machine. In that embodiment, a portion of the gaming machine overhangs the coin tray. Preferably, one or more vents are provided in that portion of the gaming machine. In the particular configuration illustrated in FIG. 11, a door portion of the gaming machine overhangs the coin tray. Preferably, the one or more vents are provided in the door.

In one embodiment, the vent may comprise a plurality of apertures in a plate or similar member forming the overhang of the door/housing.

This location of the one or more vents has several additional advantages. First, air is drawn from the front of the machine, rather than the rear or side. In situations where the gaming machine is located back-to-back or side-to-side with other machines, this eliminates problems in drawing air or obtaining cool fresh air for venting. In addition, the location of the vent is not visible, thus not detracting from the appearance of the machine.

This aspect of the invention has additional utility when the gaming machine includes the component mounting configuration described above. As described, such a mounting configuration more readily facilitates flow of cooling air through the machine.

Another embodiment of the invention is a light enclosure for a backlight of a gaming machine. Commonly, glass or similar panels are mounted in the housing or door of a gaming machine, the panel printed with instructions or similar information. In order to make the information more visible, the panel is often illuminated from the back. A problem is that the bulb of these lights is generally inaccessible. In particular, the bulb is generally closed in an enclosure which is mounted behind the panel, the enclosure reflecting directed light towards the panel. In order to remove and replace a bulb, the enclosure may need to be removed entirely in order to access the bulb.

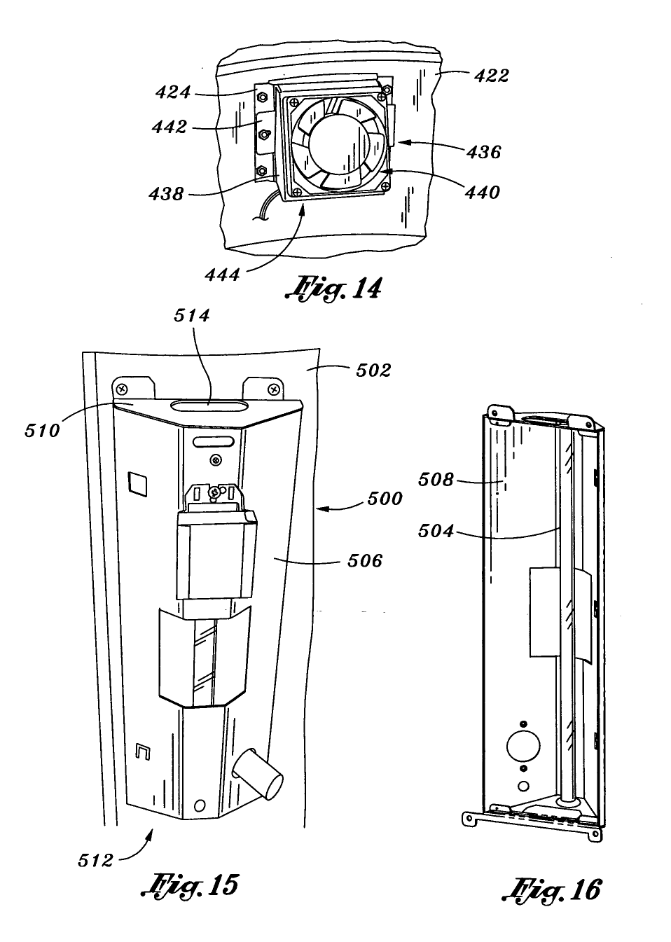

FIGS. 15 and 16 illustrated one embodiment of a light enclosure 500. In the embodiment illustrated, the light enclosure 500 is shown mounted to the inside of a gaming machine door 502, such as behind a panel which is to be illuminated. Of course, the enclosure 500 might be mounted to a housing or other support.

As illustrated, the light enclosure 500 is configured to accept one or more elongate bulb elements, such as an elongate flourescent tube 504. The particular shape and size of the light enclosure 500 may vary depending upon the particular light element which is to be enclosed.

The light enclosure 500 comprises a body 506 which defines a recessed area 508 for receiving the light element. In one embodiment, the body 506 has an inner surface and an outer surface. The enclosure 500 is configured to be mounted so that the inner surface reflects light generated by the light element forward, such as towards a panel.

As illustrated, the body 506 may define one or more mounting points for connecting the enclosure to a support, such as a door. These mounts may accept fasteners such as screws or bolts. Of course, other mounting means may be provided.

In one embodiment, one or more elements for powering the light element are associated with the enclosure. For example, a socket or sockets for accepting the light element, a ballast and/or other elements may be directly mounted to and supported by the enclosure 500. In other embodiment, one or more of those or other components may be separately mounted, and the enclosure may simply enclose the light element. In the preferred embodiment, a pair of sockets are provided for accepting the ends of the tube 504.

Preferably, the body 506 has a first end 510 and a second end 512. In one embodiment, an opening is provided in at least one of the ends. At illustrated, an access opening 514 is provided in the first end 510. The access opening 514 is preferably sized to permit access to and removal of the light element which is located in the enclosure 500 without removing the enclosure 500 from the door or other support. In the embodiment illustrated, the access opening 514 is sized to permit access to an end of the flourescent tube 504, and its removal from the enclosure 500.

Due to the location of the access opening at the first end 510, an end of the tube 504 is accessible and can be removed from its socket. The tube 504 can then be lifted out of the enclosure 500 through the access opening 514. A replacement bulb may be inserted into the enclosure in reverse. In this manner, a bulb or other light element may be replaced without having to remove the enclosure.

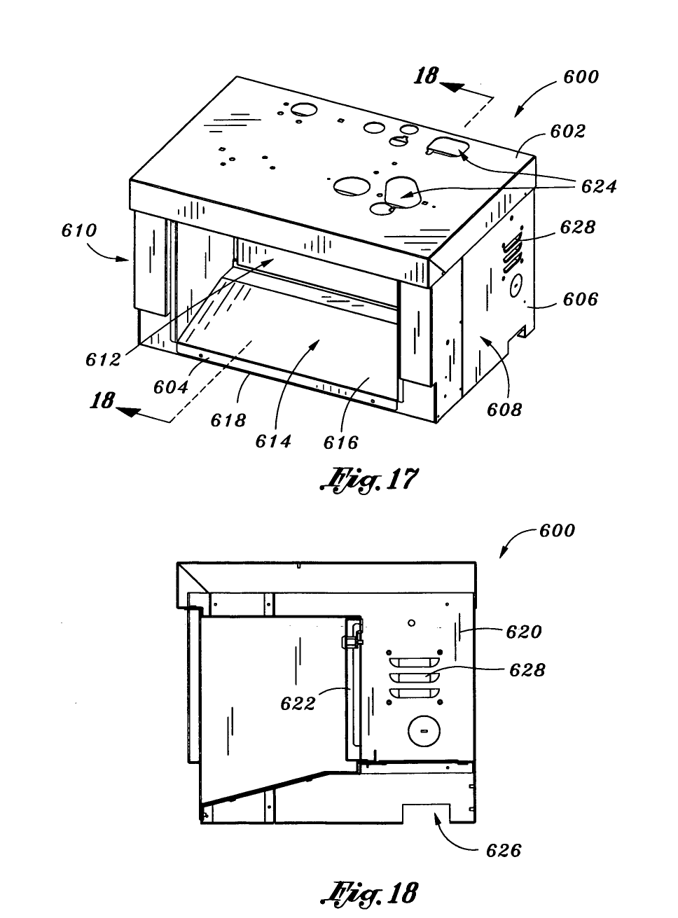

Yet another embodiment of the invention is a gaming machine stand with an integrated foot-rest area. FIGS. 17 and 18 illustrate one embodiment of the gaming machine stand 600. The stand 600 is preferably utilized to support a gaming machine. The gaming machine may be of a variety of types and of a variety of configurations. The gaming machine might be, for example, one such as illustrated in FIGS. 1-6 of the present invention.

As illustrated, the stand 600 includes a gaming machine support surface 602. The support surface 602 is elevated above a support surface by a base portion of the stand 600. In one embodiment, the base portion of the stand 600 comprises a bottom 604 and an upstanding wall 606.

In a preferred embodiment, the wall 606 forms three closed sides of the base portion, and one open side or open area. Thus, as illustrated, the wall 606 defines a first side 608, second side 610, and a back 612. A front 614 of the base portion is open between the first and second sides 608,610. The support surface 620 is located at the top of the wall 606, thus spaced from the bottom 604 of the stand 600.

The bottom 604 has a top surface 616 and a bottom surface 618. The bottom surface 618 is configured to contact a support surface. When the support surface is generally planar, the bottom surface 618 is preferably also generally planar.

Preferably, at least a portion of the top surface 616 is sloping. Referring to FIG. 16, the top surface 616 preferably slopes inwardly moving from the front 614 towards the back 612 of the base portion of the stand 600. The sloping top surface 616 of the bottom 604 of the stand 600 preferably defines a foot supporting surface. The exact angle or slop of the top surface 616 may vary but, as indicated, preferably slopes upwardly towards the back 612 of the stand 600.

In this configuration gaming stand 600, the bottom 604, support surface 602 and wall 606 define a cavity which is configured to accept a foot or both feet of a player of a gaming machine which is supported by the stand 600. It will be appreciated that the height of the support surface 602 above the top surface 616 of the bottom 604 of the stand 600 is preferably selected to provide sufficient clearance for the player's foot or feet.

As illustrated, the stand 600 may include various features relating to its support of a gaming machine. Of course, when a gaming machine is supported by the stand 600, the gaming machine is preferably oriented so that it faces towards the front of the stand (i.e. the side of the stand having the opening for accepting the player's feet).

In one embodiment, the stand 600 defines a storage area 620. Preferably, the storage area 620 is located at a rear of the stand 600, behind the foot/feet accepting opening. As illustrated, the storage area 620 is defined between the sides 608,610 at each side, by the back 612 at rear portion thereof, at the bottom by the bottom 604, at the top by the support surface 602, and at a front thereof by a panel 622.

In one embodiment, the panel 622 is mounted for movement relative to the stand 600. In one embodiment, the panel 622 is hingedly mounted to the stand 600 and movable between a raised, closed position and a lowered, open position. In the lowered position, access is preferably provided to the storage area 620 through the panel 622, as accessed through the open front 614 of the stand 600. The panel 622 may include a locking mechanism, such as a cam-type lock, which permits securing of the panel 622 into its closed position.

In one embodiment, openings or apertures 624 are provided in the support surface 602. One of more of these openings 624 preferably lead to the storage area 620. When a gaming machine is placed on the stand 600, power cords, communication cables and other equipment may be routed through the support surface 602 to the gaming machine from the storage area 620.

In one embodiment, the bottom 604 of the stand 600 may define at least one channel or passage 626. Elements such as power cords and communication cables may be routed through this channel 626. For example, a power cord may lead from a power source external to the stand 600 through the channel 626 to the storage area. So configured, the stand 600 serves as a conduit or routing member for cords and other elements connected to or leading to the gaming machine.

In one embodiment, components may be located in the storage area. For example, a processor, extra coin hopper or coin storage or other devices may be located in the storage area 620. In order to prevent excessive heat build-up from heat-generating components, one or more vents 628 may be provided. Preferably, these vents 628 lead to the storage area 620 to permit air flow exchange from the storage area 620 to a point external to the stand 600. As illustrated, the vents 628 may be located at either side 608,610 of the stand 600.

The stand 600 has numerous advantages. First, the stand 600 supports at least one gaming machine. Advantageously, the stand 600 also serves as a foot rest for a player of the game. Because the foot rest area is located within the stand 600, the player can sit closer to the machine. In addition, the combination of the stand the foot rest eliminates the need for a separate foot rest, such as are commonly provided on chairs which are located adjacent gaming machines. The stand 600 also defines a storage area and serves to hide and route gaming machine related components.

Of course, the stand 600 may have a variety of shapes and configurations, including sizes. For example, the stand 600 could be configured to support more than one gaming machine. For example, a stand might be similar to that illustrated in FIGS. 17-18 but have a generally symmetric portion at the back thereof, so as to support two gaming machines back-to-back, the stand defining two foot rest areas and at least one, if not two, storage areas. A stand might also be longer so as to accommodate two gaming machines (or more) in side-by-side relationship.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine permitting multiple configurations comprising:
a housing, said housing defining an interior area in which gaming machine components may be located, said housing having a front, at least a portion of said front open to provide access to said interior area;
a door, said door connected to said housing and moveable between a first position and a second position, said door in said first position generally closing said open portion of said front of said housing and said door in said second position permitting access through said open front portion to said interior area of said housing, said door defining:
a component area, said component area including at least one portion of said door which defines an opening, at least two gaming machine components located in said component area, said at least two gaming machine components comprising at least one display and at least one non-display component of said gaming machine;
a console area, said console area supporting one or more player input devices; and
a lower panel area.

2. The gaming machine in accordance with claim 1 wherein said at least one display comprises at least one electronic video display viewable through said opening.

3. The gaming machine in accordance with claim 1 wherein adjacent gaming machine components located in said component area are separated by a divider.

4. The gaming machine in accordance with claim 1 wherein said at least one non-display component is associated with in a component panel which is located in said opening.

5. The gaming machine in accordance with claim 1 wherein at least three components are located in said component area, said at least three components generally vertically arranged.

6. The gaming machine in accordance with claim 1 wherein said console area comprises a button panel which extends outwardly of a remainder of said door.

7. The gaming machine in accordance with claim 1 wherein said lower panel area is defined by a lower panel mounted to said door, said lower panel movable between a closed position over an opening in said door and an open position.

8. The gaming machine in accordance with claim 1 including means for biasing said lower panel into its open and closed positions.

9. The gaming machine in accordance with claim 8 wherein said means for biasing comprises a piston configured to bias said lower panel towards its open position and at least one spring configured to bias said lower panel towards its closed position.

10. The gaming machine in accordance with claim 1 wherein said door includes a periphery including a top, opposing sides and a bottom and said component area is located between said opposing sides and below said top.

11. The gaming machine in accordance with claim 1 wherein said at least two gaming machine components comprise a first display, a second display and at least one non-display component.

12. The gaming machine in accordance with claim 11 wherein said at least one non-display component is associated with a component panel, said component panel located between said first and second displays in said opening.

13. A gaming machine permitting multiple configurations comprising:
a housing;
a door, said door connected to said housing and moveable between a first position and a second position, said door in said first position generally closing an opening in said housing and said door in said second position permitting access to said interior area of said housing, said door defining:
a component area, said component area including at least one portion of said door which defines an opening, said component area configured to accept a plurality of components of said machine, said components including at least one display and at least one non-display player input device located at said opening;
a console area positioned below said component area, said console area supporting one or more player input devices; and
a panel area located below said console area.

14. The gaming machine in accordance with claim 13 wherein said plurality of components of said machine are arranged vertically within said component area of said door.

15. The gaming machine in accordance with claim 14 wherein said at least one non-display component is selected from the group consisting of: a media reader, a keypad and one or more speakers.

16. The gaming machine in accordance with claim 13 wherein said at least one non-display component is associated with a component panel located in said component area.

17. The gaming machine in accordance with claim 16 wherein said component panel extends across said opening.

18. The gaming machine in accordance with claim 13 including a bezel located over edge portions of said components.

19. The gaming machine in accordance with claim 13 wherein said housing has a top and a bottom and said door extends from said top to said bottom of said housing.
